(19) United States
(12) Patent Application Publication
(10) Pub. No.: US 2013/0094931 A1
(43) Pub. Date: Apr. 18, 2013

(54) Extending vehicle platform having a built-In ramp

(71) Applicant: Jason Bluhm, Townsend (CA)

(72) Inventor: Jason Bluhm, Townsend (CA)

(73) Assignee: Cargo Ease Inc.

(21) Appl. No.: 13/317,405

(22) Filed: Oct. 18, 2011

(51) Int. Cl. B60P 1/43

(52) U.S. Cl. 414/523

(57) ABSTRACT

An extendible device, which comprises three parts, a first of which is a framework which is stationary. A second framework is mounted on the first framework, and rolls on the first framework. The third part is a ramp which is stored in a cavity provided in the second framework.

To load equipment, one has to first extend the extendible device, pull out the ramp, and lower the ramp by pivoting it from its extended position so that the ramp ends rest on the ground, drive up or load the equipment, pivot the ramp upwardly, then slide the ramp into its stored position in the second framework, roll the extendible device to its original position, and then make sure that the freight is permanently located in the cargo carrying area.

### BACKGROUND OF THE INVENTION

Sliding platforms for vehicles, such as pickup trucks are not new. These devices have been around for quite some time. See U.S. Pat. Nos. 7,712,812; 7,121,603; 5,820,190 and 4,830,242.

U.S. Pat. No. 7,712,812 describes a Sliding Platform that extends the flat platform of the vehicle so that access may be gained to the load on the vehicle to make loading and unloading easier.

U.S. Pat. No. 7,121,603 describes a sliding platform which rides on a frame mounted in a vehicle which provides easier access to the cargo carried by such vehicle.

U.S. Pat. No. 5,820,190 describes a sliding member that is foldable into a table when extended.

U.S. Pat. No. 4,830,242 describes a sliding member that slides out of a framework in a pickup truck etc. to make it easier to gain access to a tool carrier mounted in a frame on the vehicle.

It is believed that the sliding member in each of the above patents serves to make the flat area of the vehicle body (behind the driver's compartment) much more amenable to loading and unloading freight than would have been possible had the sliding member not been present.

### SUMMARY OF THE INVENTION

The invention of this application relates to the sliding member featured in each of the Patents above. The invention relates to the addition of a ramp to be used in association with the sliding member. The invention relates to the ease of loading equipment onto the vehicle which would otherwise present an impossible task in the absence of such a ramp. In a day when the desires of the operator of the vehicle is to “get away from it all” it will be found that the ramp of this invention makes it possible to drive an All Terrain Vehicle (ATV) onto the ramp and subsequently onto the sliding member of the vehicle. This is virtually impossible without the ramp of this invention. Tying the ATV to the enclosure is a simple matter.

The use of the ramp system of this invention is not limited to the loading of ATV's; articles such as landscaping equipment may be loaded on to the sliding platform simply by pushing or driving the equipment up the ramp. It will generally be found that the equipment is too heavy or bulky to lift by hand.

The ramp system is supported by the stationary frame installed in the vehicle thus the bending of the tail gate is avoided when loading heavy equipment as with other prior art ramp systems.

### BRIEF DESCRIPTION OF THE DRAWINGS

FIG. 1 is a perspective drawing showing a pickup truck in which the ramp is mounted and the associated sliding platform is also shown.

FIG. 2 is a perspective view of sliding platform and the associated ramp in an intermediate stored position.

FIG. 2 (a) shows the enlargement of the circled area of FIG. 2.

FIG. 3 is a perspective view of the sliding platform and the associated ramp in a working position.

FIG. 3 (a) shows the enlargement of the circled area of FIG. 3.

FIG. 4 is a perspective view of the sliding hanger of this invention.

FIG. 4 (a) is a side elevational view the sliding hanger of FIG. 4.

FIG. 4 (b) is a partial front elevational view of the corner construction of the sliding hanger of FIG. 4.

FIG. 5 is a perspective view of the stationary member in which the sliding member and ramp are installed.

FIG. 5 (a) is an enlargement of the corner of the sliding member shown in FIG. (5).

### DESCRIPTION OF THE PREFERRED EMBODIMENT

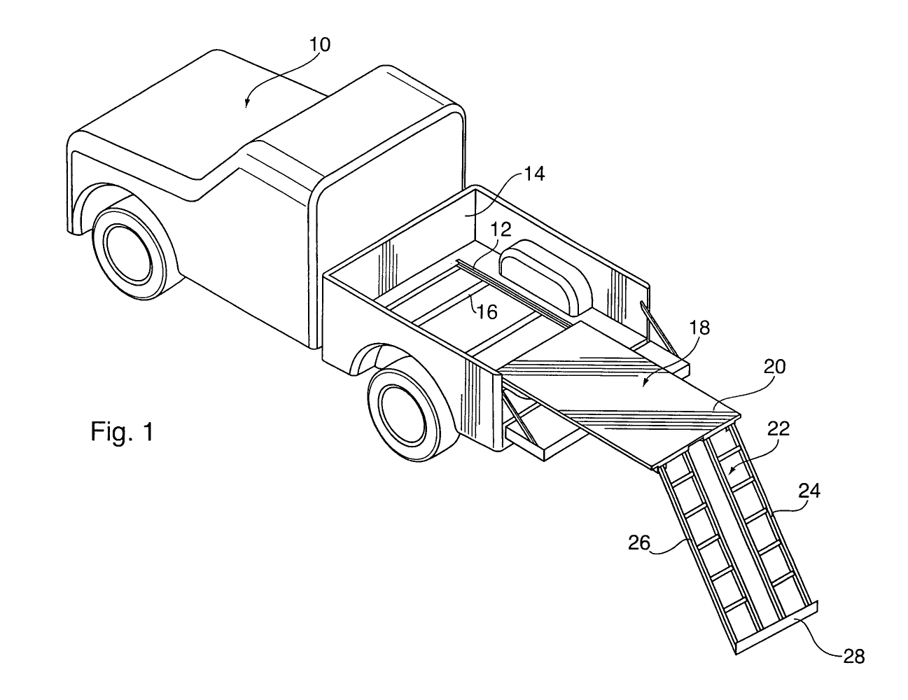

Referring to FIG. 1 now, there is illustrated a truck 10 to which this invention has been applied. It will be noted that a stationary frame member 12 has been installed in the cargo carrying space 14 of truck 10 by any suitable means. The stationary frame member 12 is shown having cross members 16 formed or installed at intervals along the length thereof for strength The stationary frame member 12 may be of any rectangular configuration but it must have sufficient strength and depth to accommodate the sliding platform 18 (which slides thereon). Sliding platform 18 is covered with a sheet of flat material 20 (plywood or other suitable material)and is arranged to slide out of cargo carrying space 14 on rollers (not shown) on stationary frame member 12. Sliding platform 18 is shown having a ramp 22 attached thereto which is captivated on the lower side of the sliding platform 18 and may be slid out from under the sliding platform 18. The sliding platform 18 when combined with an intermediate member 40, forms a joined relationship with sliding platform 18 when ramp 22 reaches the end of its travel the ramp 22 is allowed to hinge at intermediate member 50 so that it may be swung down with end 28 resting on the ground.

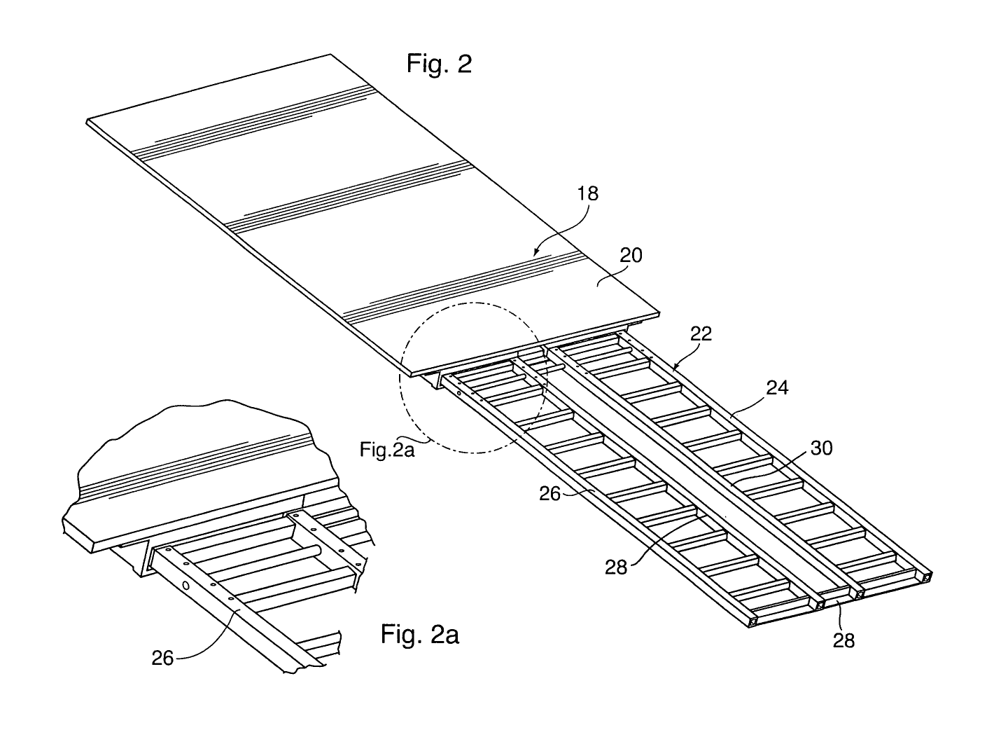

A better illustration of this arrangement will be seen by referring to FIG. 2 which shows the sliding platform 18 and the ramp 22 in the absence of the truck 10.

Here the sliding platform 18 and the ramp 22 are shown with ramp 22 being in an extended intermediate position. End 28 of the ramp 22 is about to be swung down to its working position. The opposite end of ramp 22 is hingedly coupled to an intermediate member 50 (not shown in FIG. 2) of which much will be said later.

It is noted that the ramp 22 is shown having a pair of ladder-like members 24-28 and 26-30 which are slidingly captivated below the sliding platform 18. The members 24-28 and 26-30 are captured directly below sliding platform 18 so that they are confined to motion parallel to sliding platform 18 and are limited to movement in this direction only.

The unique method of attachment of the ramp 22 to the sliding platform 18 (in working condition) when ramp 22 has reached the end of its sliding travel makes this invention possible. At the ground contacting end of the ramp 22, the ladder like elements 24 and 26 are connected together so that the structural rigidity of the ramp 22 is improved and both of the elements 24 and 26 are raised and lowered together.

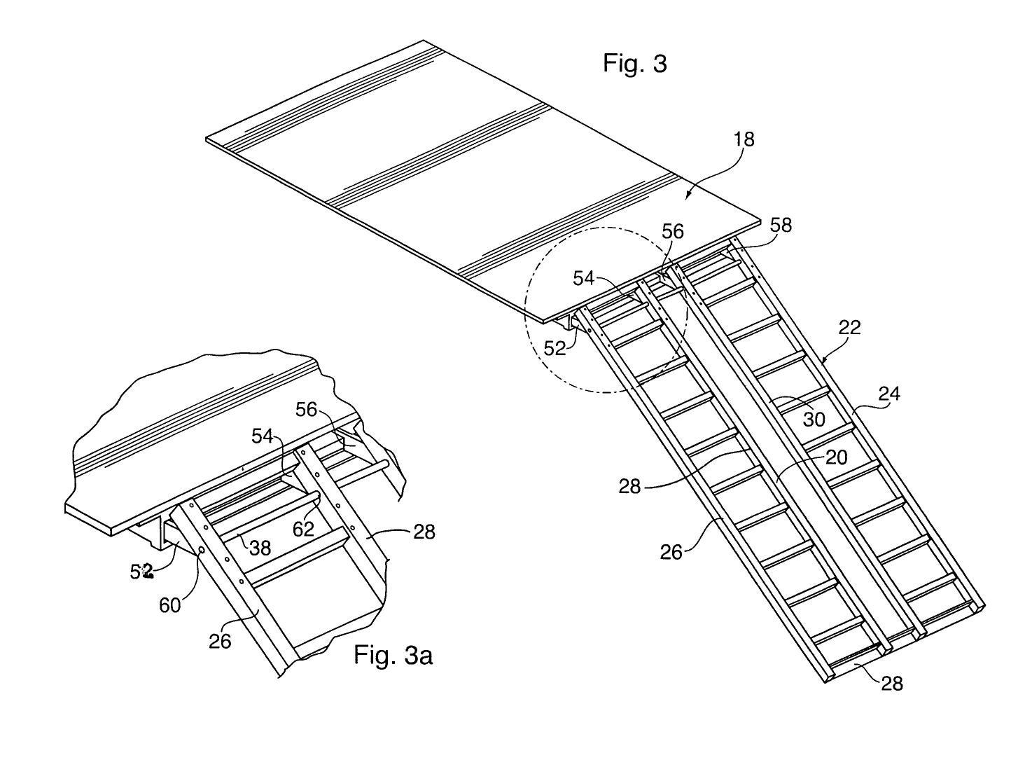

Referring now to FIG. 3, it will be noted that the ramp 22 is swung downwardly so that the ramp 22 may be used to load equipment on the sliding platform 18. It will be noted that the ramp 22 is hingedly attached to guides 52, 54, 56, and 58 of an intermediate member 50 so that a special spaced relationship will be established between the ramp 22 and the sliding platform 18 when the ramp 22 has been slid to its swung down operating position. It is noted that ramp 22 consisting of two ladder-like elements 24 and 28 and 26 and 30 is connected to element 50 in such a manner that guides 52 and 54 are attached on the inside surfaces of the extending elements 24 and 30 and 26 and 28.

Ramp 22 is attached to member 50 by means of bolt 38 which is arranged to pass through holes 60 and 62 of guides 52 and 54 connected to ladder-like members 26 and 28 of ramp 22. It is noted that members 24 and 30 are hingedly attached to the member 50 in the same manner.

This special method of attachment of the ramp 22 by means of the connection to member 50, will allow the equipment which is rolled up the ramp 22 onto the sliding platform 18 without facing a surface discontinuity at the junction of ramp 22 and the sliding platform 18. It is noted that the ramp 22 is pivotally joined to the sliding element 50 by means of bolt 38 passing through holes 60-68 of ladder-like elements 24-30 and 26-28. Holes 60-68 are situated at a predetermined distance from the upper ends of members 24-30 and 26--28. This allows the upper ends of ladder-like members 26 and 28 of the ramp 22 to project upwardly to match the surface of the sliding platform 18.

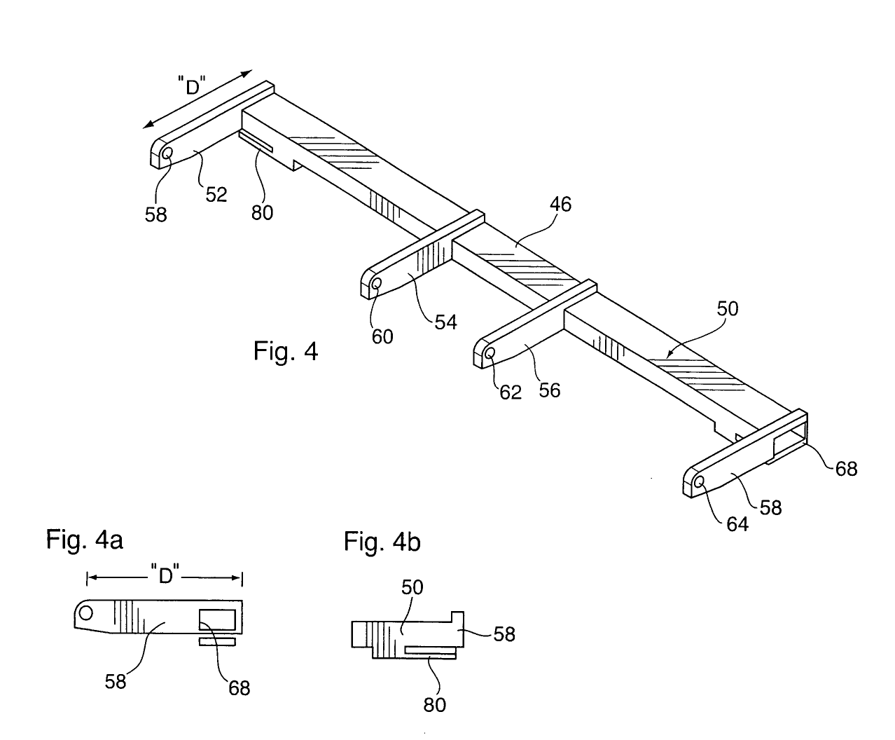

The guide members 52, 54, 56 and 58 which are arranged to slide in the slots provided under the sliding platform 18 (and to which ramp 22 is hingedly attached) will now be described in some detail with respect to FIG. 4.

Member 50 is supplied with guides 52, 54, 56 and 58 with guides 52-58 being provided with holes 58-64 bored therein at a predetermined distance “D” from the end of each guide. (see FIG. 4a). The guides 52-58 have an irregular shape so that they will slide under platform 18 (in the slots provided) and hingedly support members 24 and 30 and members 26 and 28 of ramp 22 and in their extended position.

It will be noted that the upper surface of member 50 is slightly chamfered to assist in sliding of the member 50 under the sliding platform 18. It is noted that in this instance member 50 is hollow, as shown at 62 in FIG. 4a.

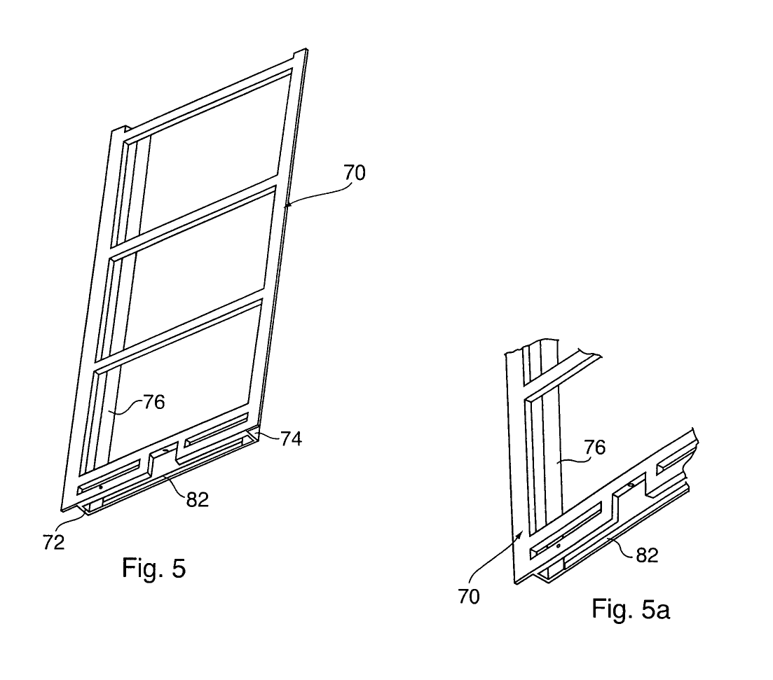

Lastly member 50 is provided with a projection 80 on the lower surface thereof. This provides a necessary stop for ramp 16 at the end of its travel under platform 14. More will be said about projection 80 later in the discussion of FIG. 5.

FIGS. 5 and 5a shows a rectangular movable framework 70 which is situated in the cargo area of the vehicle in which freight is to be hauled. The framework 70 has some depth as can be seen from FIGS. 5 and FIG. 5a. This depth is required to accommodate the ramp assembly 22 of this invention. The flat piece of plywood (or other suitable material) covering the framework 70 has been omitted from this figure for reasons of clarity A pair of slots 76 and 78 (not shown) are formed into the side members 72 and 74 of rectangular movable framework 70. Slots 76 and 78 are made to accommodate the ramp assembly 22 which is hingedly coupled to member 50 as shown in FIG. 4.

Framework member 70 rolls on wheels (not shown) on stationary mounted member 12 and ramp 22 moves with it. It is only when member 70 reaches the end of its travel on member 12 that guides 52-58 perform their function. It is at this position that ramp 22 is slid out of the slots 76 and 78 in member 70 to provide a ramp for the system.

Guides 52-56 are allowed to slide in the slots provided in member 70 until the projections such as the one shown as 80 (in FIG. 4) contact the cross member 82 as shown in FIG. 5. At this point member 50 is restrained from further movement and ramp 22 maybe swung down to its ramp position as shown in FIG. 3. It is to be noted that ramp 22 will be somewhat shorter than the sliding member 70, due to the fact that member 50 takes up some space in slots 76 ad 78 of member 70 and a lock similar to that shown in applicant's prior patent (U.S. Pat. No. 7,445,263) must be accommodated in this construction in order for the ramp 22 to function in the best mode.

Ramp 22 functions as follows: First let us assume that the ramp 22 is in its stored position in cavity 67 beneath the flat surface 18 of sliding member 70, and that the tail gate is in the “up’ travelling position on truck 10.

The vehicle 10 is stopped at the desired location and the tail gate is lowered to its (load-unload) position. It is at this point that sliding platform may be unlatched from its travelling position and rolled to its unloading position as shown in FIG. 3) At some point the wheels (not shown) of the travelling body 70 prevent any further movement of body 70. At this point the member 70 is locked in place and the ramp 22 is pulled out to the position (as defined by tangs 80 on member 50 and projection 82) as shown in FIG. 3. Ramp 22 is rotated downwardly until the end 28 rests on the ground and the ramp 22 is ready to be used.

When the equipment is loaded on the sliding member 70 (actually on flat surface 18) the process is reversed, i.e. the ramp 22 is lifted up and pushed into the cavity in sliding member 70 and when the ramp 22 is in its stored position the latch is unlatched to allow member 70 to slide to its travelling position where it is securely latched (by means of a latch similar to the one shown in applicant's prior patent) and the equipment is tied down in the cargo space of the vehicle where the ramp equipment is installed and the vehicle is driven away to its destination.

Many modifications and other embodiments of the invention will come to mind of one skilled in the art, having the benefit of the teachings presented in the foregoing description and the associated drawings. Therefore, it is to be understood that the invention is not to be limited to the specific embodiments disclosed, and that the modifications and embodiments are intended to be included within the scope of the dependent claims.

1. A ramp carrying system for a vehicle in which a ramp is incorporated into a sliding assembly mounted therein comprising:
a first stationary member which is a flat frame member of rectangular shape mounted in the freight carrying section of said vehicle, said first member having a pair of spaced apart rails formed thereon,
said ramp carrying system also comprising a second rectangularly shaped member having a frame of about the same size as the first stationary member and co-operatively mounted on said first stationary member for rectilinear movement thereon on the rails provided on said first member,
said second member being provided with a continuous flat upper surface,
said second member having a cavity formed therein,
a ramp assembly being stored in said cavity of said second member and movable therewith,
said second rectangularly shaped member having a pair of spaced apart slots formed on opposite sides of said cavity receiving said ramp assembly therein.

2. A ramp carrying system as claimed in claim 1 wherein said cavity is situated in the second member, and said ramp is of such shape that it fits into said cavity, and is slidable back and forth in said slots of said second member.

3. A ramp carrying system as claimed in claim 2 wherein said ramp assembly is slid out of said second member when said second member has reached a predetermined position.

4. A ramp carrying system as claimed in claim 3 wherein said ramp has two ladder-like sections joined together at a first end and pivotable on a sliding device at a second end, and said ramp is storable in said cavity in said second member.

5. A ramp carrying system as claimed in claim 4 wherein said ramp may be slid out of said second member and pivoted downwardly from a stored position to a ramped position after said second member has reached said predetermined position.

6. A ramp carrying system as claimed in claim 5 in which said sliding device is slidable in said slots of said second member and wherein said ramp is pivotally attached to said sliding device, said sliding device having suitable stop means to limit the travel of said sliding device in said second member.

7. A ramp carrying system as claimed in claim 5 wherein said ramp is connected to said sliding device by suitable bolt means so located that when said ramp is pivoted downwardly, said ramp and said upper surface of said second member form a continuous surface at the junction thereof.

8. A ramp carrying system as claimed in claim 6 wherein said bolt means passes through said ladder-like sections of said ramp at a predetermined distance from the second end thereof, and said sliding device comprises four outstanding projections wherein said bolt means passes through said projections of said sliding device at a predetermined distance from the ends of said projections

9. An extending platform for use in association with a pickup truck comprising:
a first framework being stationary and being mounted in the cargo carrying space of said pickup truck, said first framework being shallow and extending almost the length of the cargo carrying space of said pickup truck,
a second rolling framework of the same size as said first framework, mounted on said first framework to co-operate with said first framework to extend the length of said pickup truck,
said second framework being shallow and having a top surface which is smooth and continuous and said second framework having a cavity located below said top surface for carrying a ramp therein, said second framework being movable on said first framework,
a ramp being stored in said cavity and being movable with respect to said second framework to slide out of said cavity of said second framework, when said second framework is extended,
said ramp being pivoted from a sliding device in said second framework so that a continuous surface is formed at the junction of said upper surface and said ramp when said ramp is pivoted downwardly.

10. A extending platform as claimed in claim 8 in which said first framework has a pair of spaced apart parallel rails mounted in said cavity and where in said second framework rolls on said rails

11. An extending platform as claimed in claim 9 wherein said second framework has a pair of slots formed in said cavity for slidably engaging said ramp and said sliding device therein.

12. An extending platform as claimed in claim 10 wherein said cavity also contains an sliding device that co-operates with said slots formed in said cavity to slide in said slots formed in said cavity and pivotally mounts said ramp on guides formed on said sliding device.
